(19) United States
(12) Patent Application Publication
(10) Pub. No.: US 2012/0080857 A1
(43) Pub. Date: Apr. 5, 2012

(54) CLO'S MOBILE MED HELPER SYSTEMS

(76) Inventor: Charlotte Smith, Scottsboro, AL (US)

(21) Appl. No.: 13/252,823

(22) Filed: Oct. 4, 2011

Related U.S. Application Data
(60) Provisional application No. 61/389,370, filed on Oct. 4, 2010.

(51) Int. Cl. B62B 3/00; A47B 85/00; A47B 81/00

(52) U.S. Cl. 280/29; 312/209

(57) ABSTRACT

Clo's Mobile Med Helper comprises a small portable medical cart that converts into a workstation. The device is designed to hold medical supplies and can be easily transported in a vehicle. The invention is comprised of a medical cart that is similar in size and shape to a standard suitcase on two wheels. It also includes a pullout handle. The design includes drawers, or compartments, of various sizes and may be user-customizable. These drawers hold a variety of medical supplies and tools. Each drawer may be labeled according to its contents. The design also includes a slide out table that can be pulled out from the top side of the design, when standing upright. The tabletop will fit securely on top of the unit. There may be a small recess where the table will be secured thereby to prevent movement. There may also be a small hook that drops down from underneath the tabletop in which to hang a garbage bag.

### CROSS-REFERENCE TO RELATED APPLICATION

The present application is related to and claims priority from prior provisional application Ser. No. 61/389,370, filed Oct. 4, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of medical equipment carrying cases and more specifically relates to a portable carrying case for use in transporting medical supplies that may also serve as a workstation.

### 2. DESCRIPTION OF THE RELATED ART

Many individuals require the assistance and care of home health and hospice nurses. These individuals may have to transport various supplies back and forth between homes and traditional healthcare facilities. The supplies are often packed into multiple bags, which traditionally must be carried by the healthcare provider. This can cause strain to the neck and back and may result in serious injuries. These individuals may also be required to go through a bag technic process, which consists of a specific method for unpacking their equipment; it may be difficult to find a suitable location to set their bag(s) in order to perform this task. Further, once the healthcare provider begins treatment there is often no sanitary or convenient place on which to set the supplies and equipment for ready access. An effective solution to these problems is needed.

Various attempts have been made to solve the above-mentioned problems such as those found in U.S. Pat. And Pub. Nos. 2005/0145458; 6,343,694; 2004/0108241; 2006/0228201; 5,848,700; and 7,398,978. This prior art is representative of storage and transport devices. None of the above inventions and patents, taken either singly or in combination, is seen to describe the invention as claimed.

Ideally, a portable convertible medical cart and workstation system should be lightweight, durable, user-friendly, sanitary and, yet would operate reliably and be manufactured at a modest expense. Thus, a need exists for a reliable portable convertible medical cart and workstation system to avoid the above-mentioned problems.

### BRIEF SUMMARY OF THE INVENTION

In view of the foregoing disadvantages inherent in the known medical storage and transport device art, the present invention provides a novel portable convertible medical cart and workstation system. The general purpose of the present invention, which will be described subsequently in greater detail is to provide convenience for healthcare providers delivering such services in various remote locations.

Clo's Mobile Med Helper of the present invention comprises a portable medical equipment carrying case that acts as a workstation when deployed. This product is ideal for use by those in the healthcare field, especially those that work in home health and hospice. It allows the individual to carry the equipment needed to do their job in a sterile and efficient manner. The product substantially eliminates the need for nurses to carry heavy, cumbersome bags, which can cause strain to the neck and back. The device doubles as a workstation so that individuals are able to perform their job competently and conveniently.

A portable convertible medical cart and workstation system is described herein preferably comprising: a medical cart assembly having, an outer enclosure having a back wall, a top wall, a bottom wall, a right sidewall and a left sidewall, a plurality of drawers each having an inner volume for storing medical supplies, tools and medical equipment, a slide out table, a handle, tracks located on the right sidewall and the left sidewall, channel runners linked via a stop, at least one bag hanger hook, and wheels for permitting rolling of the medical cart assembly on a horizontal planar surface (wherein the horizontal planar surface comprises a ground or floor surface or the like.)

The drawers are preferably substantially contained within the outer enclosure (when the drawers are in a closed orientation and supported by the outer enclosure via tracks/sliders or the like) wherein the drawers are able to be opened to access the supplies contained therewithin. The plurality of drawers provide sterile storage of the medical supplies, tools and medical equipment, a desirable feature when using medical equipment. The drawers may comprise labels for denoting a particular storage location of the various medical supplies, tools and medical equipment contained within the inner volume(s) of drawers such that it is easy to find the desired item with relative ease, helping the treatment/service(s) to be cost-effective.

In certain embodiments a bottom drawer (or others) may comprises a lock assembly having a tumbler which is lockable via keys, push buttons, combination spin locks or the like to provide security if needed. The drawers may be partitioned/divided by vertical-dividers; wherein the vertical-dividers are removably replaceable such that the inner volumes of the drawers are size-user-customizable to suit the application and/or user-preference(s). For ease of access the drawers each have a hand-handle in preferred embodiments.

Tracks may be used providing sliding means for the drawers to open and close on via sliders allowing each of the drawers to slide horizontally parallel with the top wall and the bottom wall between open and closed conditions (perpendicular to the back wall, and sidewalls.) A bag hanger hook may be located on a top of the right (or left) sidewall of the outer enclosure to deposit (medical or other) garbage therein. The bag hanger hook is preferably located behind the slide out table when the slide out table is in a non-use condition and the bag hanger hook is accessible to hang and access at least one bag when the slide out table is in an in-use condition (during treatment for example.)

The slide out table is located adjacent and parallel to the right sidewall in the channel runners during the non-use condition (stored vertically.) The slide out table is slidable moveable from within the channel runners up and across to the in-use-position adjacent and parallel to the top wall during an in-use period creating a workbench table-top, handy for setting tools, supplies and medicines for example during treatments for easy access. The slide out table comprises a substantially planar surface such that the handle is receivably-covered thereby creating a smooth surface whereby the medical supplies, tools and medical equipment is surface-storable during the in-use condition so the healthcare provider doesn't have to look through drawers to find equipment during treatment procedures.

In certain embodiments the slide out table comprises a handle recess wherein the handle is not permitted to obstruct the slide out table from resting in a stationary condition adjacent the top wall during the in-use condition, such that the planar surface is substantially level and non-moving in relation to the outer enclosure. This provides stability to the slide out table and objects set upon it.

The channel runners further comprise a stop located on the right (or left) sidewall, wherein the slide out table is substantially prevented from downward sliding movement caused by gravitational force(s) once the slide out table contacts the stop (a channel beam or the like) thereby retaining the slide out table within the channel runners during the in-use condition. The handle is usable to pull-manipulate and push-manipulate the medical cart assembly to transport the portable convertible medical cart and workstation system between locations, such as from a vehicle into a house or healthcare facility. In certain embodiments the handle is telescopic to provide ease of motion and comfort when pulling or pushing the device to or from the vehicle. Thus, the user is able to adjust the handle according to his/her preference.

In the above manners the portable convertible medical cart and workstation system is able to be readily converted between a medical cart and a workstation via changing the relative positioning of the slide out table in relation to the outer enclosure of the device. The portable convertible medical cart and workstation system is lightweight (made of plastic or other suitable equivalent) and is readily transportable in at least one vehicle such that it may be lifted into the vehicle by exactly one user with relative ease. Upon reading this specification, it should be appreciated that, under appropriate circumstances, considering such issues as user preferences, design preference, structural requirements, marketing preferences, cost, available materials, technological advances, etc., other materials such as, for example, aluminum, composites, various types of plastics, etc., may be sufficient to comprise portable convertible medical cart and workstation system.

A method of using a portable convertible medical cart and workstation system is also disclosed herein preferably comprising the steps of: stocking the drawers of the portable convertible medical cart and workstation system with medical supplies, tools and medical equipment for at least one medical treatment, wherein the medical treatment(s) may be performed at least one remote location; transporting the portable convertible medical cart and workstation system to the remote location(s) in a vehicle; and providing the medical treatment at the remote location(s) using the medical supplies, tools and medical equipment to perform the treatment of at least one patient. The method of using a portable convertible medical cart and workstation system may further comprise the step of manipulating the slide out table from a stored non-use position (vertical) to an in-use position (horizontal) wherein the slide out table is located adjacent the top wall of the medical cart assembly to perform the medical treatment and returning the slide out table to the stored non-use position located on a right or left sidewall for movement in transport to another remote location(s).

The present invention holds significant improvements and serves as a portable convertible medical cart and workstation system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, portable convertible medical cart and workstation system entitled ‘Clo's Mobile Med Helper Systems’, constructed and operative according to the teachings of the present invention.

FIG. 1 shows a perspective view illustrating a medical cart assembly of a portable convertible medical cart and workstation system in an in-use condition according to an embodiment of the present invention.

FIG. 2 is a perspective view illustrating the medical cart assembly in a non-use condition (and drawer-closed orientation) according to an embodiment of the present invention of FIG. 1.

FIG. 3 is a perspective view illustrating drawers having dividing means, (top drawer in a closed condition and a middle drawer in an open condition), inner volumes of the drawers as used to store medical supplies, tools and medical equipment within an outer enclosure of the medical cart assembly according to an embodiment of the present invention of FIG. 1.

FIG. 4A is a perspective view illustrating a user lifting the medical cart assembly into a vehicle for transport to a remote location according to an embodiment of the present invention of FIG. 1.

FIG. 4B is a perspective view illustrating the user pull-manipulating the medical cart assembly to remote location(s) according to an embodiment of the present invention of FIG. 1.

FIG. 5 is a flowchart illustrating a method of use for the portable convertible medical cart and workstation system according to an embodiment of the present invention of FIGS. 1-4B.

The various embodiments of the present invention will hereinafter be described in conjunction with the appended drawings, wherein like designations denote like elements.

### DETAILED DESCRIPTION

As discussed above, embodiments of the present invention relate to a storage and transport device and more particularly to a portable convertible medical cart and workstation system as used to improve the convenience and efficiency for healthcare providers delivering such services in various remote locations.

Generally speaking, Clo's Mobile Med Helper of the present invention comprises a small portable medical cart that quickly converts into a stable workstation. It is designed to hold medical supplies and can be easily transported in a vehicle. The invention is comprised of a medical cart that is similar in size and shape to a standard suitcase on two wheels. It also may include a pullout handle. The design is made from a material that is more durable than traditional luggage material and doesn't harbor dust or other harmful elements. The design includes dividable drawers, or compartments, of various sizes. These drawers hold a variety of medical supplies and tools. Each drawer may be labeled with indicia/color-coding or the like to denote the drawers contents. The design also preferably includes a slide out table that can be pulled out from the top side of the device (when the device is standing upright.) The tabletop will fit securely on top of the outer enclosure. There may be a small cutout (recess/receiving means) whereby the table top will be securable (secured.) There may also be a small hook that drops down from underneath the tabletop in which to hang a garbage bag to dispose of medical trash. There may be a lock on the bottom drawer that can be locked with a key.

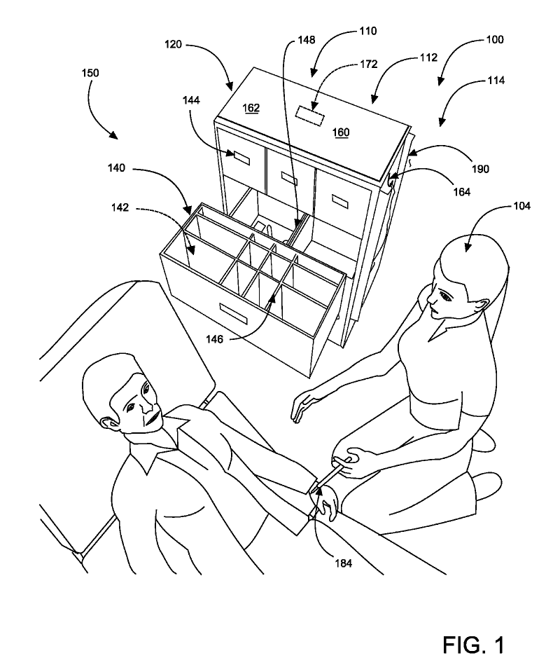

Referring now more specifically to the drawings by numerals of reference there is shown in FIG. 1, a perspective view illustrating medical cart assembly 110 of portable convertible medical cart and workstation system 100 in an in-use condition 150 according to an embodiment of the present invention.

In preferred embodiments portable convertible medical cart and workstation system 100 comprises: medical cart assembly 110 (having outer enclosure 120 including back wall 122, top wall 124, bottom wall 126, right sidewall 128 and left sidewall 130); a plurality of drawers 140 each having an inner volume 142 for storing medical supplies 180, tools 182 and/or medical equipment 184; a slide out table 160, and handle 170.

The plurality of drawers 140 are substantially contained and supported within members of outer enclosure 120 (back wall 122; top wall 124; bottom wall 126; right sidewall 128; and left sidewall 130); wherein drawers 140 are able to provide substantially sterile storage of medical supplies, tools and medical equipment, 180; 182; and 184, respectively.

Slide out table 160 is preferably located in a non-use-position adjacent and parallel to right sidewall 128 in channel runners 190 during a non-use condition. Slide out table 160 is slidable moveable from within channel runners 190 to an in-use-position adjacent and parallel to top wall 124 during an in-use period creating workbench table-top 162.

Handle 170 is usable to pull-manipulate and push-manipulate medical cart assembly 110 to transport portable convertible medical cart and workstation system 100 between locations. In this way portable convertible medical cart and workstation system 100 is able to be readily converted between medical cart 112 and workstation 114 via changing relative positioning of slide out table 160 in relation to outer enclosure 120; and wherein portable convertible medical cart and workstation system 100 is readily transportable in at least one vehicle 102.

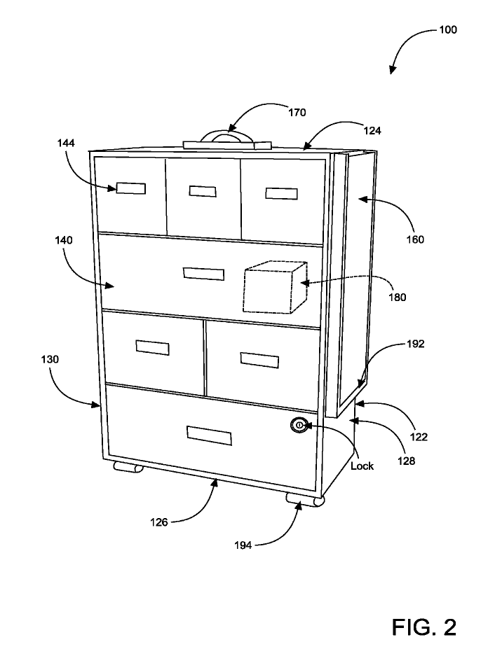

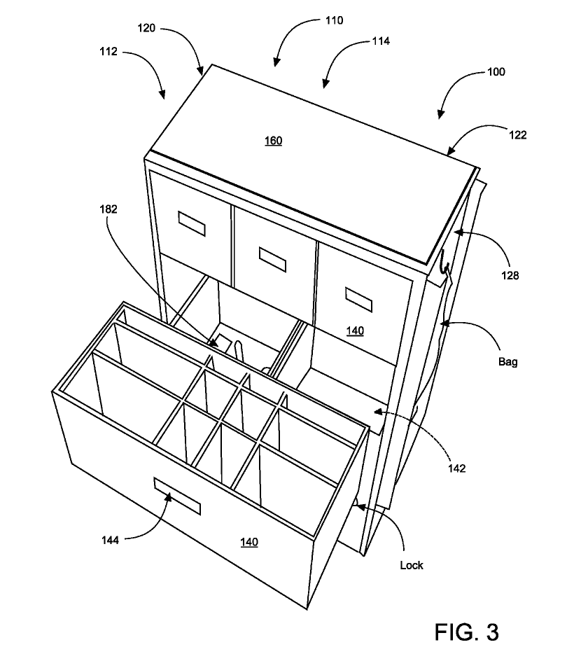

Portable convertible medical cart and workstation system 100, in certain preferred embodiments may further comprise bag hanger hook 164. Bag hanger hook 164 is preferably located on a top portion of right sidewall 128 of outer enclosure 120 for ease of access. Bag hanger hook 164 is thereby located behind slide out table 160 when slide out table 160 is in the non-use condition (as in FIG. 2.) Slide out table 160 comprises a planar surface such that handle 170 is covered (over) thereby creating a smooth surface where medical supplies, tools and medical equipment (180; 182; and 184, respectively) are surface-storable during in-use condition 150. Slide out table 160 preferably comprises handle recess 172 wherein handle 170 is not permitted to obstruct, but rather secure slide out table 160 in stasis while slide out table 160 is sitting in a stationary condition adjacent top wall 124 during in-use condition 150 (shown in FIGS. 1 and 3.)

Referring now to FIG. 2, a perspective view illustrating medical cart assembly 112 in a non-use condition (and drawer-closed orientation) according to an embodiment of the present invention of FIG. 1.

The plurality of drawers 140 may comprise labels with indicia for denoting locations of medical supplies, tools and medical equipment (180; 182; and 184, respectively) contained within inner volume(s) 142 of drawers 140. Some or all of drawers 140 may be lockable for security reasons to prevent loss and tampering of medical supplies, tools and medical equipment (180; 182; and 184, respectively). Drawers 140 may each have hand-handle(s) 144.

Channel runners 190 as used within portable convertible medical cart and workstation system 100 may further comprise stop 192 (illustrated best in FIGS. 1-3) located on a lower portion of right sidewall 128, wherein slide out table 160 is prevented from downward sliding movement once slide out table 160 touch-contacts stop 192, thereby retaining slide out table 160 within confines of channel runners 190 during the non-use condition.

Referring now to FIG. 3, a perspective view illustrating drawers 140 having dividing means, (top drawer in a closed condition and a middle drawer in an open condition), inner volumes 142 of drawers 140 as used to store medical supplies 180, tools 182 and medical equipment 184 within an outer enclosure 120 of medical cart assembly 110 according to an embodiment of the present invention of FIG. 1.

Drawers 140 may be dividable by vertical-dividers 146 (also shown in FIG. 1). Vertical-dividers 146 are removably replaceable such that inner volumes 142 of drawers 140 are size-user-customizable (into smaller or larger compartments.) In this way the present invention is partitionable with relative ease.

Portable convertible medical cart and workstation system 100 may further comprise tracks 148. Tracks 148 provide sliders (controlled and supported sliding in and out means) allowing each of drawers 140 to slide horizontally parallel with top wall 124 and bottom wall 126 to and fro an adjacent position with back wall 122 allowing movement between open and closed conditions.

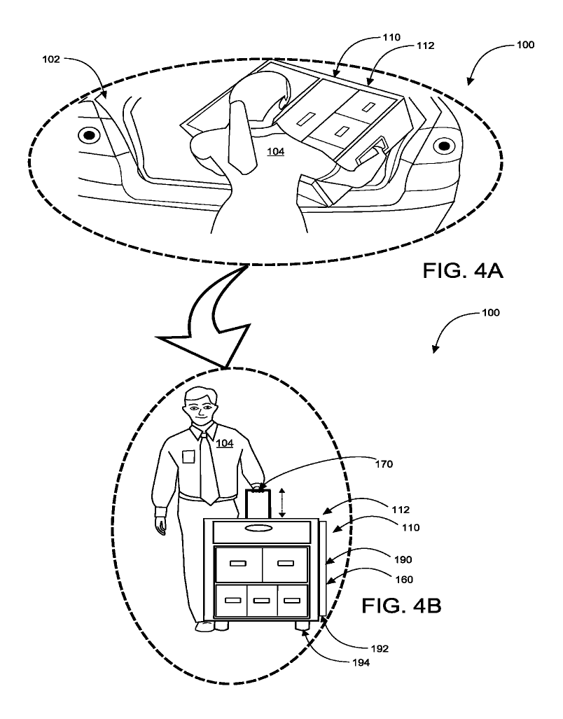

Referring now to FIG. 4A showing a perspective view illustrating user 104 (healthcare provider or other such individual) lifting medical cart assembly 110 into vehicle 102 for transport to a remote location according to an embodiment of the present invention of FIG. 1.

Portable convertible medical cart and workstation system 100, since it is relatively lightweight, may be lifted into vehicle 102 by exactly one user 104. In this way the present invention is convenient in-use. More than one user 104 may be used to lift the present invention should it be heavily loaded with medical supplies 180, tools 182, and/or medical equipment 184.

FIG. 4B is a perspective view illustrating user 104 pull-manipulating (or push-manipulating) medical cart assembly 110 to remote location(s) according to an embodiment of the present invention of FIG. 1.

For ease of transport medical cart assembly 110 of portable convertible medical cart and workstation system 100 further comprises wheels 194. For ease of use and comfort in pull-manipulating or push-manipulating operations handle 170 is preferably telescopic. Telescopic versions provide that outer enclosure 120 has a handle recess (not shown) such that handle 170 when ‘telescoped in’ is able to be substantially contained within confines of medical cart assembly 110.

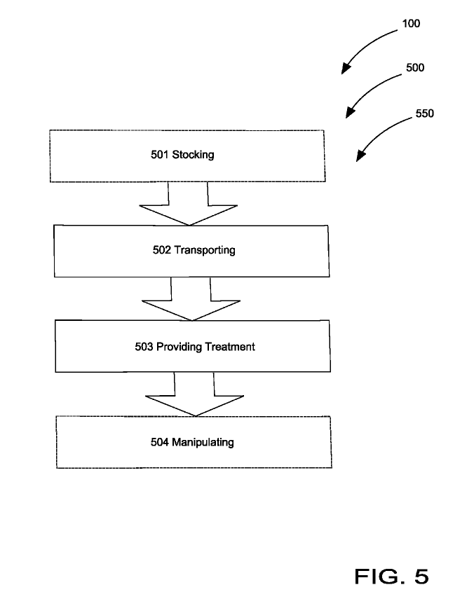

Referring now to FIG. 5, a flowchart 550 illustrating a preferred method of use 500 for portable convertible medical cart and workstation system 100 according to an embodiment of the present invention of FIGS. 1-4B.

A method 500 of using portable convertible medical cart and workstation system 100 preferably comprises the steps of: step one 501 stocking drawers 140 of medical cart assembly 110 of portable convertible medical cart and workstation system 100 with medical supplies, tools and medical equipment (180; 182; and 184, respectively) for at least one medical treatment, wherein the medical treatment(s) will be performed at least one remote location; step two 502 transporting medical cart assembly 110 of portable convertible medical cart and workstation system 100 to the remote location(s); and step three 503 providing the medical treatment at the remote location(s) using medical supplies 180, tools 182 and medical equipment 184.

The method of using (at least hereby enabling preferred method of use 500) may further comprise step four 504 of manipulating slide out table 160 from a stored non-use position to an in-use position wherein slide out table 160 is located adjacent top wall 124 of medical cart assembly 110 to perform the medical treatment(s) and returning slide out table 160 to stored the non-use position located on right or left sidewall (128 and 130, respectively) for movement in transport to another remote location.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable convertible medical cart and workstation system comprising:
a medical cart assembly having,
an outer enclosure having a back wall, a top wall, a bottom wall, a right sidewall and a left sidewall,
a plurality of drawers each having an inner volume for storing medical supplies, tools and medical equipment,
a slide out table, and
a handle,
wherein said plurality of drawers are contained within said outer enclosure;
wherein said plurality of drawers provide sterile storage of said medical supplies, said tools and said medical equipment;
wherein said slide out table is located in a non-use-position adjacent and parallel to said right sidewall in channel runners during a non-use condition;
wherein said slide out table is slidable moveable from within said channel runners to an in-use-position adjacent and parallel to said top wall during an in-use period creating a workbench table-top;
wherein said handle is usable to pull-manipulate and push-manipulate said medical cart assembly to transport said portable convertible medical cart and workstation system between locations;
wherein said portable convertible medical cart and workstation system is able to be readily converted between a medical cart and a workstation via changing said relative positioning of said slide out table in relation to said outer enclosure; and
wherein said portable convertible medical cart and workstation system is readily transportable in at least one vehicle.

2. The portable convertible medical cart and workstation system of claim 1 further comprising wheels.

3. The portable convertible medical cart and workstation system of claim 1 further comprising a bag hanger hook.

4. The portable convertible medical cart and workstation system of claim 1 wherein said handle is telescopic.

5. The portable convertible medical cart and workstation system of claim 1 wherein said plurality of drawers comprise labels with indicia for denoting said medical supplies, said tools and said medical equipment contained within said inner volume(s) of said drawers.

6. The portable convertible medical cart and workstation system of claim 1 wherein said plurality of drawers are lockable.

7. The portable convertible medical cart and workstation system of claim 1 wherein said drawers are dividable by vertical-dividers.

8. The portable convertible medical cart and workstation system of claim 1 wherein said vertical-dividers are removably replaceable such that the inner volumes of said drawers are size-user-customizable.

9. The portable convertible medical cart and workstation system of claim 1 wherein said plurality of drawers each has a hand-handle.

10. The portable convertible medical cart and workstation system of claim 1 further comprising tracks.

11. The portable convertible medical cart and workstation system of claim 10 wherein said tracks provide sliders allowing said plurality of drawers to slide horizontally parallel with said top wall and said bottom wall to and fro an adjacent position with said back wall between open and closed conditions.

12. The portable convertible medical cart and workstation system of claim 3 wherein said bag hanger hook is located on a top of said right sidewall of said outer enclosure.

13. The portable convertible medical cart and workstation system of claim 12 wherein said bag hanger hook is located behind said slide out table when said slide out table is in said non-use condition.

14. The portable convertible medical cart and workstation system of claim 1 wherein said slide out table is a planar surface such that said handle is covered thereby creating a smooth surface where said medical supplies, said tools and said medical equipment is surface-storable during said in-use condition.

15. The portable convertible medical cart and workstation system of claim 14 wherein said slide out table comprises a handle recess wherein said handle is not permitted to obstruct, but rather secure said slide out table in stasis while said slide out table is sitting in a stationary condition adjacent said top wall during said in-use condition.

16. The portable convertible medical cart and workstation system of claim 13 wherein said channel runners further comprise a stop located on a lower portion of said right sidewall, wherein said slide out table is prevented from downward sliding movement once said slide out table contacts said stop thereby retaining said slide out table within confines of said channel runners during said non-use condition.

17. The portable convertible medical cart and workstation system of claim 1 wherein said portable convertible medical cart and workstation system may be lifted into said vehicle by exactly one user.

18. A portable convertible medical cart and workstation system comprising:
a medical cart assembly having,
an outer enclosure having a back wall, a top wall, a bottom wall, a right sidewall and a left sidewall,
a plurality of drawers each having an inner volume for storing medical supplies, tools and medical equipment,
a slide out table,
a handle,
tracks located on said right sidewall and said left sidewall,
channel runners linked via a stop,
at least one bag hanger hook, and
wheels for permitting rolling of said medical cart assembly on a horizontal planar surface;
wherein said horizontal planar surface comprises a ground or floor surface;
wherein said handle is telescopic;
wherein said plurality of drawers are contained within said outer enclosure when in a closed orientation;
wherein said plurality of drawers provide sterile storage of said medical supplies, said tools and said medical equipment;
wherein said plurality of drawers comprise labels for denoting a storage location of said medical supplies, said tools and said medical equipment contained within said inner volume(s) of said drawers;
wherein a bottom said drawer comprises a lock assembly having a tumbler which is lockable;
wherein said drawers are divided by vertical-dividers;
wherein said vertical-dividers are removably replaceable such that the inner volumes of said drawers are size-user-customizable;
wherein said plurality of drawers each has a hand-handle;
wherein said tracks provide sliders allowing said plurality of drawers to slide horizontally parallel with said top wall and said bottom wall between open and closed conditions;
wherein said bag hanger hook is located on a top of said right sidewall of said outer enclosure;
wherein said bag hanger hook is located behind said slide out table when said slide out table is in said a non-use condition;
wherein said bag hanger hook is accessible to hang and access at least one bag when said slide out table is in said in-use condition;
wherein said slide out table is located in a non-use-position adjacent and parallel to said right sidewall in said channel runners during said non-use condition;
wherein said slide out table is slidable moveable from within said channel runners to said in-use-position adjacent and parallel to said top wall during an in-use period creating a workbench table-top;
wherein said slide out table is a planar surface such that said handle is receivably-covered thereby creating a smooth surface where said medical supplies, said tools and said medical equipment is surface-storable during said in-use condition;
wherein said slide out table comprises a handle recess wherein said handle is not permitted to obstruct said slide out table from resting in a stationary condition adjacent said top wall during said in-use condition;
wherein said channel runners further comprise said stop located on said right sidewall, wherein said slide out table is substantially prevented from downward sliding movement caused by gravitational force(s) once said slide out table contacts said stop thereby retaining said slide out table within said channel runners during said in-use condition;
wherein said handle is usable to pull-manipulate and push-manipulate said medical cart assembly to transport said portable convertible medical cart and workstation system between locations;
wherein said portable convertible medical cart and workstation system is able to be readily converted between a medical cart and a workstation via changing relative positioning of said slide out table in relation to said outer enclosure;
wherein said portable convertible medical cart and workstation system is readily transportable in at least one vehicle; and
wherein said portable convertible medical cart and workstation system may be lifted into said vehicle by exactly one user.

19. A method of using a portable convertible medical cart and workstation system comprising the steps of:
stocking drawers of said portable convertible medical cart and workstation system with medical supplies, tools and medical equipment for at least one medical treatment, wherein said medical treatment(s) will be performed at least one remote location;
transporting said portable convertible medical cart and workstation system to said remote location(s); and
providing said medical treatment at said remote location(s) using said medical supplies, said tools and said medical equipment.

20. The method of using a portable convertible medical cart and workstation system of claim 19 further comprising the step of manipulating a slide out table from a stored non-use position to an in-use position wherein said slide out table is located adjacent a top wall of a medical cart assembly to perform said medical treatment and returning said slide out table to said stored non-use position located on a right or left sidewall for movement in transport to another said remote location.
